(19) United States
(12) Patent Application Publication
(10) Pub. No.: US 2015/0040554 A1
(43) Pub. Date: Feb. 12, 2015

(54) Dynaco Stepper Pump Hydraulic System

(71) Applicants: Gary L. Smith, Thames (NZ); Laurens MOLENAAR, Te Aroha (NZ)

(72) Inventors: Gary L. Smith, Thames (NZ); Laurens MOLENAAR, Te Aroha (NZ)

(21) Appl. No.: 14/452,760

(22) Filed: Aug. 6, 2014

(30) Foreign Application Priority Data
Aug. 7, 2013 (NZ) 614055

(51) Int. Cl. F15B 11/12; F03C 1/013; F15B 21/00; F04B 49/06; F15B 11/06; F03C 1/00; F04B 17/03

(52) U.S. Cl. CPC F15B 11/12; F03C 1/002; F03C 1/003; F03C 1/013; F04B 17/03; F04B 49/06; F15B 11/06; F15B 21/001; F05C 2225/08; F05C 2201/0433; F05C 2201/021; F05C 2201/00; F05C 2201/0481; F05C 2201/90
USPC 60/446; 60/478; 60/445; 60/449; 60/451; 417/410.1

(57) ABSTRACT

A hydraulic linear actuator system known as the “Dynaco Stepper Pump Hydraulics System” is which is an electrically driven hydraulic pump system made of durable materials for use in an electronically controllable hydraulic system comprised of: (a) an electrically driven stepper motor; (b) a hydraulic pump to pressurize a hydraulic fluid; (c) a means to connect the stepper motor to the hydraulic pump; (d) a pressurized reservoir for a quantity of hydraulic fluid; (e) a means to supply pressurized fluid to a hydraulic actuator; (f) the hydraulic actuator with a means to provide linear motion to an object; (g) the means to provide linear motion to an object; (h) a means to return lowered pressurized fluid to the reservoir. An alternative embodiment is further comprised of a controller with a series of feedback signals.

### CROSS-REFERENCE TO RELATED APPLICATIONS

This application claims the benefit of Provisional Patent Application in New Zealand with Serial Number 614055 filed Aug. 7, 2013 by Gary L. Smith and Laurens Molenaar and entitled “Hydraulic System”.

### FIELD OF INVENTION

This invention relates to a “Dynaco” Stepper Pump Hydraulic System. This invention further relates to hydraulic pumps and to hydraulic systems, and in particular, but not exclusively, to electronically controllable hydraulic systems for use in controlled hydraulic and robotic systems. The present invention relates to self-contained actuator systems and, in particular, it concerns a self-contained hydraulic actuator system having a pump and components, the pumping assembly of which is adjustable so as to control the speed and direction of the fluid flow through the system and an actuator responsive to the fluid flow.

### FEDERALLY SPONSORED RESEARCH

None.

### SEQUENCE LISTING OR PROGRAM

None.

### BACKGROUND, PROBLEM SOLVED AND PRIOR ART

1. Background

Hydraulic systems are being used increasingly in plant and equipment in industrial applications. These hydraulic systems and circuits are useful in that they allow relatively large forces to be applied, the hydraulic supply lines can be lengthy, and can be flexible without incurring significant power transmission losses or reliability issues. In addition, hydraulic circuits operate relatively smoothly and quietly, and with minimal backlash. These features of hydraulic circuits can be most significant in the area of robotics where machines are designed to emulate human dexterity to some extent. While gear boxes that convert rotational motion into linear movement were at the heart of many early industrial machines, hydraulic circuits and hydraulic components have largely superseded the use of such components. However, for conventional hydraulic circuits to be efficient, i.e. to be light weight and compact and yet powerful, they need to operate at constant high pressures. It is not uncommon for modern hydraulic systems to operate at pressures in the region of twenty to forty Mega Pascals (MPa), aka 3,000 to 6,000 PSI.

Conventional hydraulic pump systems that use “constant pressure” (conventional systems) often have an electric motor continuously running to drive a pump at one speed. Energy is continuously consumed and any excess pressure is placed back into a standard (fluid only) reservoir. One of the challenges of conventional hydraulics systems is that they use control valves to try and get precise control. This creates a very complex situation, resulting in more things that can go wrong and more components can fail. For example, modern complex machines require frequent and often minute or precise movements. To do this, enormous stress is placed on these control valves that manage the flow of the high pressure fluids. Another challenge is that while accumulators may be used to maintain hydraulic pressure for a period of time in some hydraulic systems, it is more common to run hydraulic pumps continuously while operating hydraulic equipment to ensure that full system pressure is maintained at all times. This practice is wasteful as to energy and causes wear in the pumps and relief valves.

To cope with the increased demand for energy conservation and the need for better control, hydraulic systems improvements were next developed having a variable-displacement type pump. These improved systems would normally depend on a pumping system referred to as or called a “servo pump”. In these servo systems, the servo pump is used as a driving source for providing fluid power and driving an actuator such as a hydraulic cylinder, hydraulic motor or the like. It is recommended and often taught in these hydraulic systems that the servo pump should be situated as closely as possible to the actuator. This proximity is in order to eliminate unfavorable effects and conditions such as damage and leakage which may be incurred through the piping system.

2. Problem Solved

While the servo pump systems did provide some improvements on conventional systems, their limitations are still significant. For example, servo pumps have limited torque for a given size machine and it takes time to reach the torque needed for some hydraulic systems. What is still needed is an even more efficient and precise manner in which the control and operation of hydraulic circuits can be achieved. Higher and faster torque is needed than what the conventional and most servo systems can efficiently provide. Often there is not enough space to allow a larger servo pump system to be used. Or the weight of a larger servo is too great for a given application. Under this circumstance, attempts have been made to reduce the sizes of the pump and motor to realize a compact construction of the servo pump as a whole. As a matter of fact, however, there still is a practical limit in the reduction of the size and weight of the servo pump due to structural reasons. Modern electronics are allowing greater flexibility with control systems and modern mechanical components are allowing greater complexity of design of many machines, especially automated machines. A hydraulic system with distinct improvements using a precise stepper motor to drive the pump is presented here. The system called a “Dynaco Stepper Pump Hydraulics System” promotes and supports the increased use of hydraulic systems in general.

3. Prior Art

Several conventional and servo pump prior art systems and devices have tried to solve the problem of precise control for hydraulic systems. As compared to the simplicity of the “Dynaco Stepper Pump Hydraulic System,” these systems and devices are mechanically and/or electrically more complicated. Included are:

(a) U.S. Pat. No. 4,529,362 issued to Ichiryu, et al. in 1985 entitled “Servo pump for hydraulic systems” shows and teaches a servo pump for use in a hydraulic system. The servo pump is constituted by a variable displacement type hydraulic pump adapted to be driven by a high-speed motor and to hydraulically drive an actuator. The motor and the pump are housed in a common casing. These are used primarily in injection mold presses and are considered an improvement over the conventional hydraulic systems.

(b) U.S. Pat. No. 4,850,812 by Voight was issued in 1989 and is entitled “Integrated motor pump”. This taught an integrated motor pump unit for use as a hydraulic fluid pressure source at a remote location incorporates a pump rotor affixed in the center of a motor rotor. The motor/pump rotor assembly spins on a fixed shaft in a combination providing both radial journal and axial thrust bearings. The stationary shaft assembly incorporates a piston drive mechanism which is angled, relative to the shaft axis, so that reciprocal movement of the pistons is developed as they rotate about the axis.

(c) U.S. Pat. No. 7,640,736 issued to Arbel, et al. in 2010 is entitled “Self-contained hydraulic actuator system” and shows a hydraulic linear actuator system of the present invention includes a pump that is configured to rotate in a single direction at a substantially constant velocity. Both the direction and flow rate of fluid through the system is controlled by adjusting the positional relationship between the stator and the rotor of the pump. This positional relationship is adjustable between a forward flow state, a non-flow state and a reverse flow state. And finally,

(d) U.S. Pat. No. 6,494,039 issued to Pratt et al. in 2002 and entitled “Force-controlled hydro-elastic actuator” teaches a force-controlled hydro-elastic actuator, including a hydraulic actuator, having a connection to hydraulic fluid and including a mechanical displacement member positioned to be mechanically displaced by fluid flow at the actuator. A valve is connected at the hydraulic actuator connection and has a port for input and output of fluid to and from the valve.
None of these prior art inventions shown above anticipate, suggest or indicate the new “Dynaco Stepper Pump Hydraulics System”.

### SUMMARY OF THE INVENTION

This invention is a Special “Dynaco Stepper Pump Hydraulics System”. Taught here are the ways a precise stepper motor used in a hydraulic system may overcome the limitation faced by the servo pump and conventional systems. One or more of the “Dynaco Stepper Pump Hydraulics Systems” is/are placed and removably secured in place to control the system as described herein.

The preferred embodiment of the “Dynaco Stepper Pump Hydraulics System” is an electrically driven hydraulic pump system made of durable materials for use in an electronically controllable hydraulic system comprised of: (a) an electrically driven stepper motor; (b) a hydraulic pump to pressurize a hydraulic fluid; (c) a means to connect the stepper motor to the hydraulic pump; (d) a pressurized reservoir for a quantity of hydraulic fluid; (e) a means to supply pressurized fluid to a hydraulic actuator; (f) the hydraulic actuator with a means to provide motion to an object; (g) a means to return lowered pressurized fluid to the reservoir. An alternative embodiment is further comprised of a controller with a series of feedback signals.

### OBJECTS AND ADVANTAGES

There are several objects and advantages of the “Dynaco Stepper Pump Hydraulics System”. There are currently no known hydraulic system and/or devices that are effective at providing the objects of this invention. The “Dynaco Stepper Pump Hydraulics System” is an electrically controllable hydraulic system that resolves the challenges of conventional hydraulics systems by: removing the need for having to use hydraulic proportional control valves; removing the requirement to continuously run the hydraulic pumps so required high pressures can be maintained at all times (i.e., a centralized pressure system) and requiring no proportional control valves, yet still providing 100% proportional control. While application benefits are numerous, one specific application advantage the “Dynaco Stepper Pump Hydraulics System” has over conventional systems that are driven directly by electric motors is in the operation of an industrial robotic arm because the heavy and bulky components that are normally mounted on the arm (like motors and gearboxes) are replaced with lightweight hydraulic components. In addition to the reduction in weight that the arm has to carry, the hydraulic power unit can be scaled to any size because it is remote from the actual robot arm.

The “Dynaco Stepper Pump Hydraulics System” provides the following advantages and benefits over the servo pump system:

| | |
|---|---|
| A | provides more precise control than servo; |
| B | has higher reliability since it has less components; |
| C | provides a smaller mechanical footprint for any |
| | given torque required; |
| D | is easier to drive and control the system from an |
| | electrical and power perspective; |
| E | size for size, it consumes less power to provide the |
| | same torque; |
| F | provides a more energy efficient system, especially |
| | at higher loads, since the added electrical poles |
| | allows the stepper motor to hold the pump in a fixed |
| | position, locking the actuator in place. |

*Additional benefits are shown in paragraph (0039) and details and discussions are shown in the operations section below.

Finally, other advantages and additional features of the present “Dynaco Stepper Pump Hydraulics System” will be more apparent from the accompanying drawings and from the full description of the device. For one skilled in the art of carefully controlled hydraulic systems, it is readily understood that the features shown in the accompanying drawings and descriptions with this system are readily adapted to other types of hydraulic systems and devices.

### DESCRIPTION OF THE DRAWINGS—FIGURES

The accompanying drawings, which are incorporated in and constitute a part of this specification, illustrate an embodiment of the “Dynaco Stepper Pump Hydraulics System” that is preferred. The drawings together with the summary description given above and a detailed description given below serve to explain the principles of the “Dynaco Stepper Pump Hydraulics System”. It is understood, however, that the system is not limited to only the precise arrangements and instrumentalities shown.

FIG. 1 is a sketch of the “Dynaco Stepper Pump Hydraulics System”.

FIGS. 2A and 2B are isometric sketches of the “Dynaco Stepper Pump Hydraulics System” with components and features noted.

FIGS. 3A through 3D are Front, Side and Top views of the “Dynaco Stepper Pump Hydraulics System” with the components and features shown.

FIGS. 4A and 4B are sketches of a stepper motor and pump and a hydraulic ram of the “Dynaco Stepper Pump Hydraulics System,” with more of the components and features demonstrated.

FIGS. 5A through 5C are sketches of the “Dynaco Stepper Pump Hydraulics System” in several operating configurations.

FIG. 6 is a sketch of an alternative embodiment for the “Dynaco Stepper Pump Hydraulics System”.

### DESCRIPTION OF THE DRAWINGS—REFERENCE NUMERALS

The following list refers to the drawings:

TABLE
Reference numbers

| Ref # | Description |
|---|---|
| 11 | “Dynaco Stepper Pump Hydraulics System” 11 |
| 13 | electrically driven positive placement hydraulic pump 13 |
| 15 | hydraulic actuator in form of a hydraulic ram 15 |
| 16 | ram spear piston 16 |
| 17 | supply lines 17 |
| 19 | return lines 19 |
| 21 | electric stepper motor or equal 21 |
| 23 | pump 23 gear (preferred), worm, centrifugal, piston, or equal |
| 25 | hydraulic reservoir 25 |
| 26 | hydraulic fluid 26 |
| 27 | pressurized gas 27 |
| 28 | cover plate, fasteners and gaskets 28 |
| 30 | bell housing 30 |
| 31 | pump gears 31 |
| 31A | worm gears 31A |
| 31B | piston pump 31B |
| 31C | centrifugal pump 31C |
| 31D | swashplate pump 31D |
| 32 | pump housing 32 |
| 33 | oil pump mounting plate 33 |
| 34 | pump shaft 34 |
| 35 | cap screw fasteners or equal means of fastening 35 |
| 36 | control valve and regulator mechanism 36 |
| 38 | shutoff valve 38 |
| 40 | single drive and actuator 40 |
| 45 | hydraulic drive and multiple (parallel) actuators 45 |
| 46 | hydraulic drive and multiple (parallel and series) actuators |
| | 46 |
| 50 | Alternative embodiment 50 with feedback 51 and controller 52 |
| 51 | feedback signal 51 (for example and not limitations from |
| | electrical current - amp, motor/shaft speed - RPM, hydraulic |
| | fluid pressure - psi, and actuator position - position to |
| | datum) |
| 52 | controller 52 that uses feedback 51 signals and adjusts |
| | stepper motor 21 |

### DETAILED DESCRIPTION OF PREFERRED EMBODIMENT

The present development is a “Dynaco Stepper Pump Hydraulics System” for specific and controlled hydraulic pump systems. This invention relates to hydraulic pumps and to hydraulic systems, and in particular, but not exclusively, to electronically controllable hydraulic systems for use in controlled hydraulic and robotic systems. The present invention relates to self-contained actuator systems and, in particular, it concerns a self-contained hydraulic linear actuator system having a pump and components, the pumping assembly of which is adjustable so as to control the speed and direction of the fluid flow through the system and a linear actuator responsive to the fluid flow.

The advantages for the “Dynaco Stepper Pump Hydraulics System” 11 are listed above in the introduction. Succinctly, the benefits of this Dynaco Stepper Pump Hydraulics System over a servo pump system are that it:
1. provides more precise control than servo;
2. has higher reliability since it has less components;
3. provides a smaller mechanical footprint for any given torque required;
4. is easier to drive and control the system from an electrical and power perspective;
5. size for size, consumes less power to provide the same torque;
6. is more energy efficient, especially at higher loads, since the added electrical poles allows the stepper motor to hold the pump in a fixed-position, locking the actuator in place.

The preferred embodiment of the “Dynaco Stepper Pump Hydraulics System” is an electrically driven hydraulic pump system made of durable materials for use in an electronically controllable hydraulic system comprised of: (a) an electrically driven stepper motor; (b) a hydraulic pump to pressurize a hydraulic fluid; (c) a means to connect the stepper motor to the hydraulic pump; (d) a pressurized reservoir for a quantity of hydraulic fluid; (e) a means to supply pressurized fluid to a hydraulic actuator; (f) the hydraulic actuator with a means to provide motion to an object; (g) a means to return lowered pressurized fluid to the reservoir. An alternative embodiment is further comprised of a controller with a series of feedback signals.

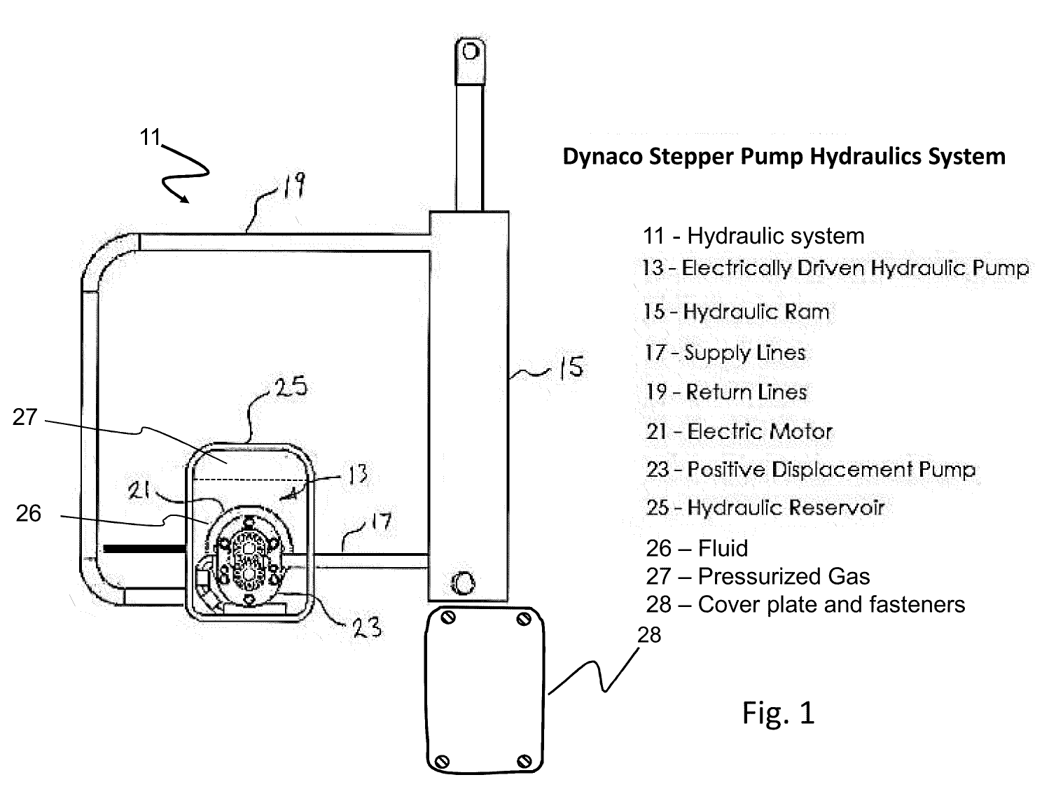

There are shown in FIGS. 1-6 a complete description and operative embodiment of the “Dynaco Stepper Pump Hydraulics System”. In the drawings and illustrations, one notes well that the FIGS. 1-6 demonstrate the general configuration and use of this product. The various example uses are in the operation and use section, below.

The accompanying drawings, which are incorporated in and constitute a part of this specification, illustrate an embodiment of the “Dynaco Stepper Pump Hydraulics System” 11 that is preferred. The drawings together with the summary description given above and a detailed description given below serve to explain the principles of the “Dynaco Stepper Pump Hydraulics System” 11. It is understood, however, that the “Dynaco Stepper Pump Hydraulics System” 11 is not limited to only the precise arrangements and instrumentalities shown. Other examples of hydraulic systems with and without feedback control and their uses are still understood by one skilled in the art of hydraulic pump systems to be within the scope and spirit shown here.

FIG. 1 is a sketch of the “Dynaco Stepper Pump Hydraulics System” 11. Demonstrated here are the “Dynaco Stepper Pump Hydraulics System” 11; electrically driven positive placement hydraulic pump 13; hydraulic actuator in form of a hydraulic ram 15; ram spear piston 16; supply lines 17; return lined 19; electric stepper motor or equal 21; pump 23 gear (preferred), worm, centrifugal, piston, or equal; hydraulic reservoir 25; hydraulic fluid 26; pressurized gas 27 air or nitrogen or other preferably inert gas); and cover plate, fasteners and gaskets 28. The reservoir 25 and fluid 26 is pressurized with compressed gas 27 (air or inert gas) to allow a positive flow of fluid 26 to the positive displacement pump and to provide pressure to retract the hydraulic actuator or ram 15.

The components are comprised of durable materials for example and not as a limitation: a metal such as steel, steel alloy, aluminum, brass, pot metal and may be coated with a powder coat, paint, or other surface finish. They may also be made of a heavy duty, durable plastic or composite material.

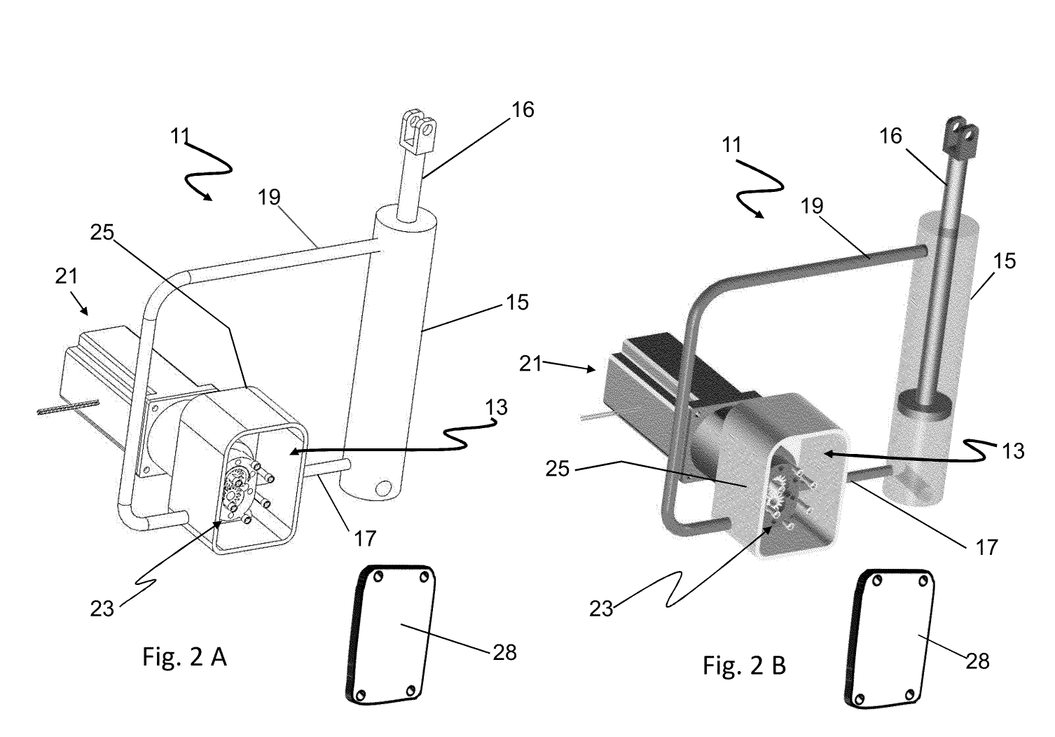

FIGS. 2A and 2B are isometric sketches of the “Dynaco Stepper Pump Hydraulics System” 11 with components and features noted. Shown are the “Dynaco Stepper Pump Hydraulics System” 11; electrically driven positive placement hydraulic pump 13; hydraulic actuator in form of a hydraulic ram 15; ram spear piston 16; supply lines 17; return lined 19; electric stepper motor or equal 21; pump 23 gear (preferred), worm, centrifugal, piston, or equal; hydraulic reservoir 25; and cover plate, fasteners and gaskets 28.

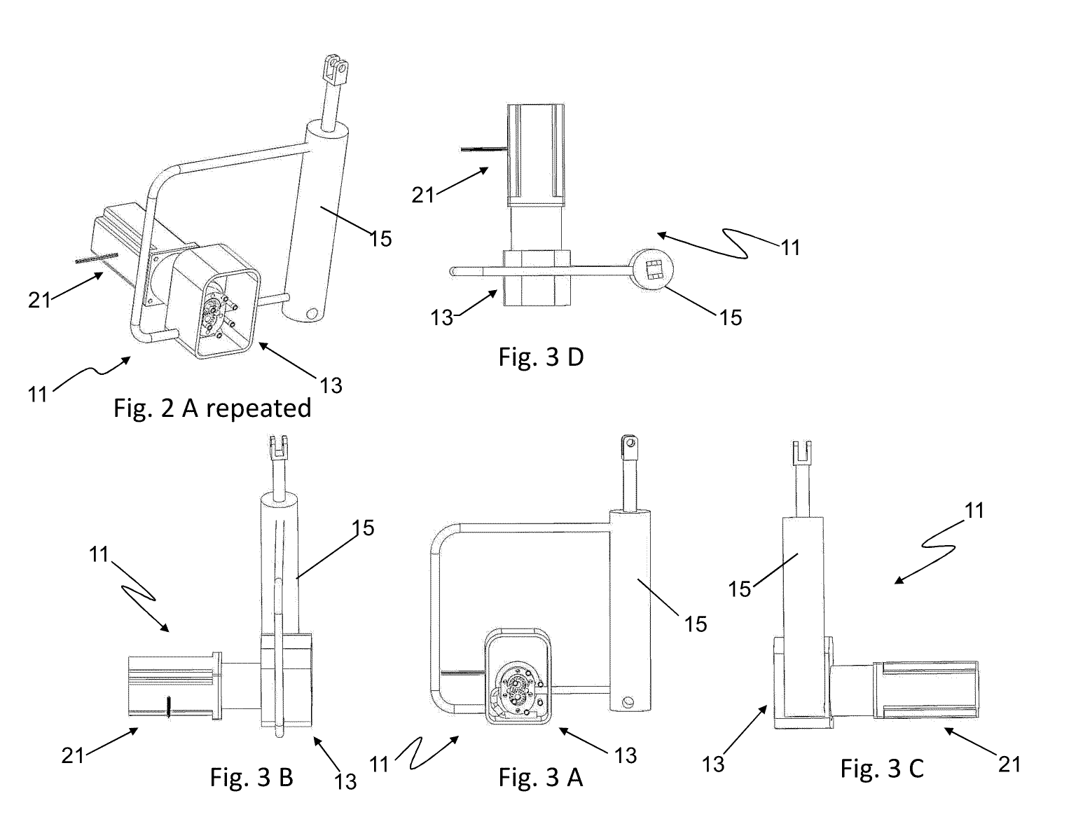

FIGS. 3A through 3D are Front, Side and Top views of the “Dynaco Stepper Pump Hydraulics System” with the components and features shown. Again demonstrated in these views are the “Dynaco Stepper Pump Hydraulics System” 11; electrically driven positive placement hydraulic pump 13; hydraulic actuator in form of a hydraulic ram 15; ram spear piston 16; supply lines 17; return lined 19; electric stepper motor or equal 21; pump 23 gear (preferred), worm, centrifugal, piston, swashplate or equal; hydraulic reservoir 25; and cover plate, fasteners and gaskets 28.

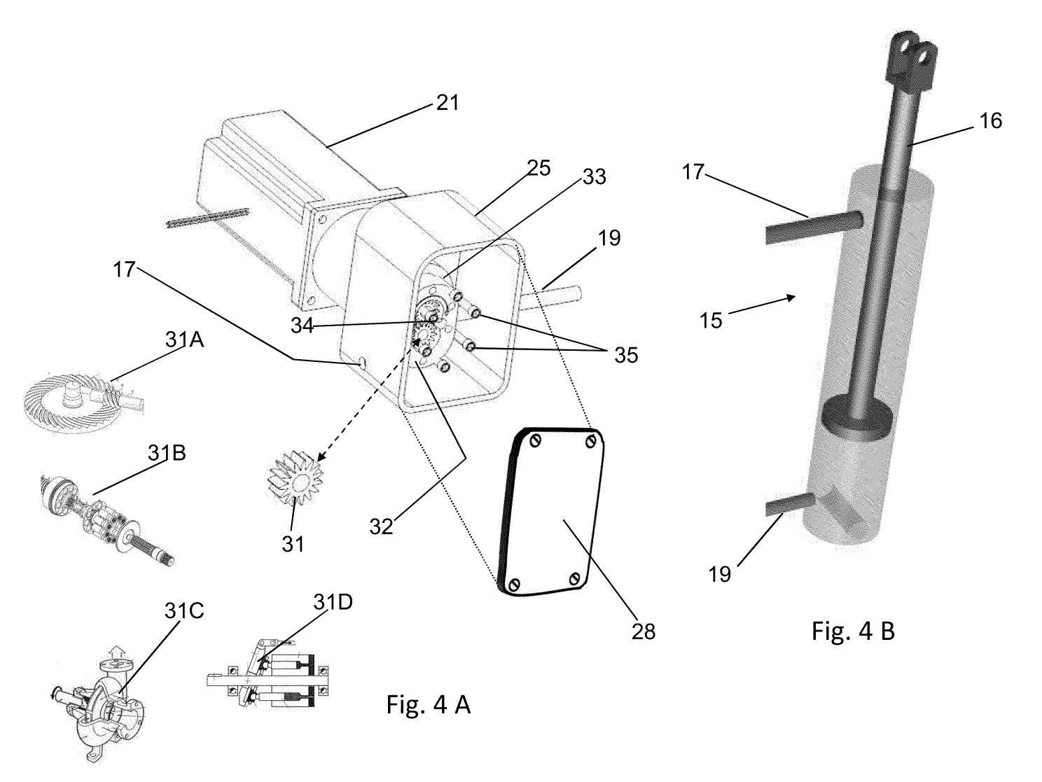

FIGS. 4A and 4B are sketches of a stepper motor 21 and pump 13 and a hydraulic ram 15 of the “Dynaco Stepper Pump Hydraulics System” with more of the components and features demonstrated. Here are shown the “Dynaco Stepper Pump Hydraulics System” 11; electrically driven positive placement hydraulic pump 13; hydraulic actuator in form of a hydraulic ram 15; ram spear piston 16; supply lines 17; return lined 19; electric stepper motor or equal 21; pump 23 gear (preferred), worm, centrifugal, piston, or equal; hydraulic reservoir 25; and cover plate, fasteners and gaskets 28. In addition are shown: bell housing 30; pump gears 31—worm gears 31A; piston pump 31B; centrifugal pump 31C; swashplate pump 31D; pump housing 32; oil pump mounting plate 33; pump shaft 34; and cap screw fasteners or equal means of fastening 35.

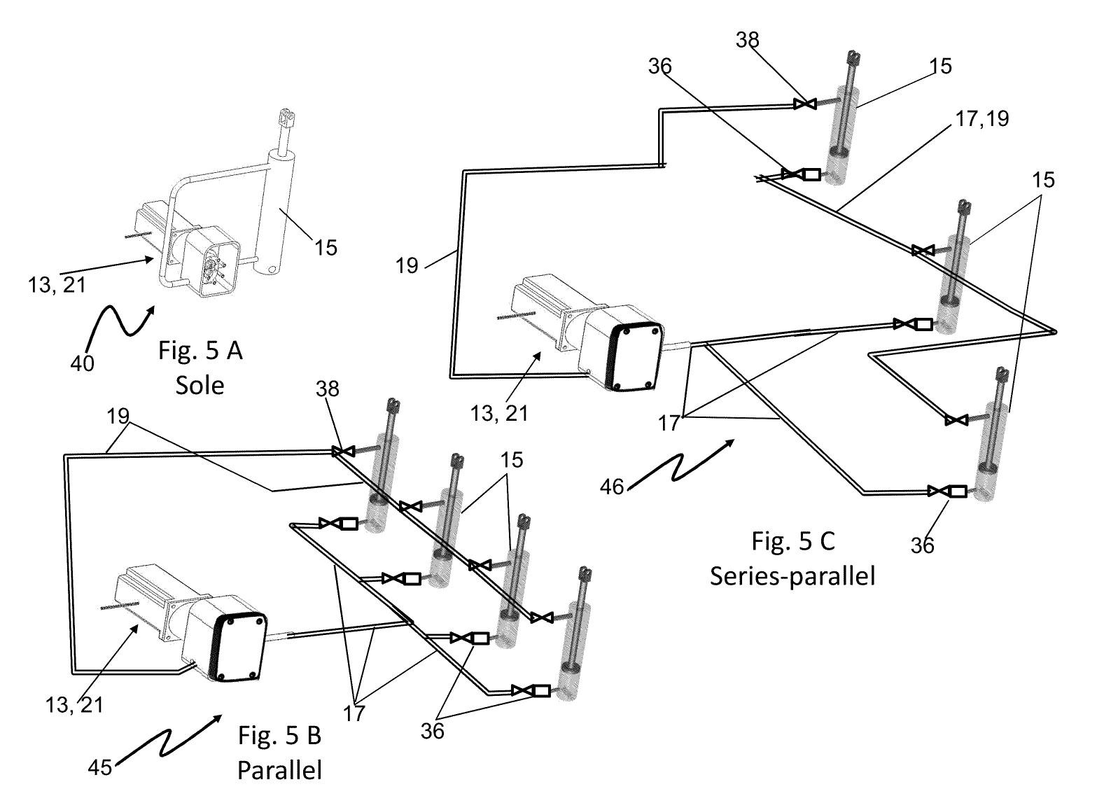

FIGS. 5A through 5C are sketches of the “Dynaco Stepper Pump Hydraulics System” in several operating configurations. They are described in the operations section below.

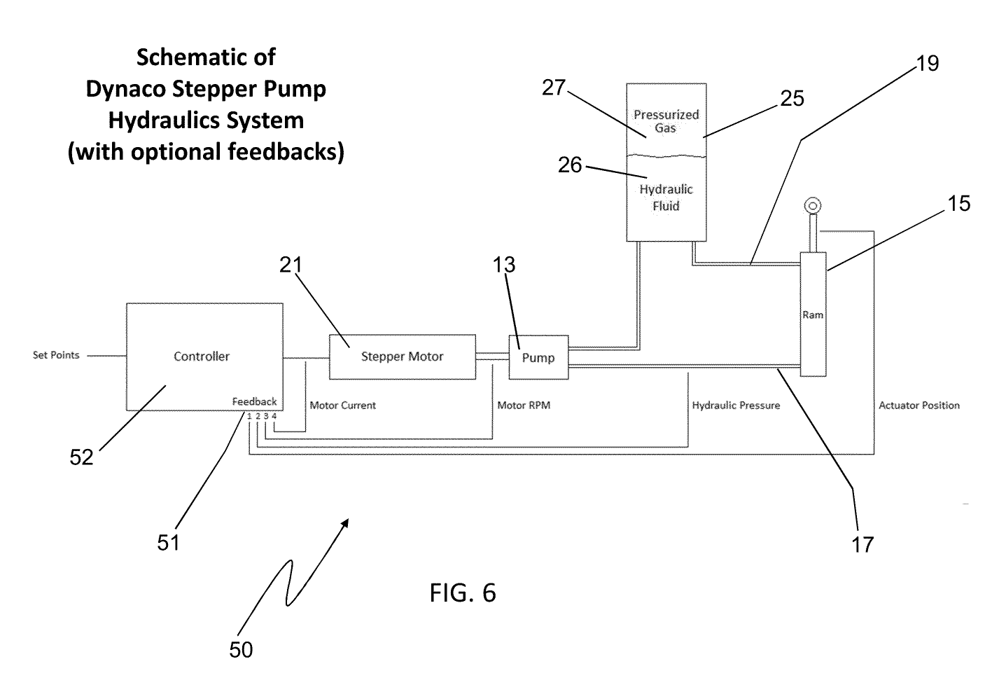

FIG. 6 is a sketch of an alternative embodiment 50 for the “Dynaco Stepper Pump Hydraulics System”. Most of the components have been described above. Note the addition of the feedback signal 51 (for example and not limitations from electrical current—amp, motor/shaft speed—RPM, hydraulic fluid pressure—psi, and actuator position—position to datum) as well as the controller 52 that uses feedback 51 signals and adjusts stepper motor 21. Note also the hydraulic reservoir 25; hydraulic fluid 26; and pressurized gas 27 (air or nitrogen or other preferably inert gas). The reservoir 25 and fluid 26 is pressurized with compressed gas 27 (air or inert gas) to allow a positive flow of fluid 26 to the positive displacement pump and to provide pressure to retract the hydraulic actuator or ram 15

The details mentioned here are exemplary and not limiting. Other specific components and manners specific to describing a “Dynaco Stepper Pump Hydraulics System” 11 may be added as a person having ordinary skill in the field of hydraulic systems, devices and their uses well appreciates.

### Operation of the Preferred Embodiment

The “Dynaco Stepper Pump Hydraulics System” 11 has been described in the above embodiment. The manner of how the device operates is described below. One notes well that the description above and the operation described here must be taken together to fully illustrate the concept of the “Dynaco Stepper Pump Hydraulics System” 11. The preferred embodiment of the “Dynaco Stepper Pump Hydraulics System” is an electrically driven hydraulic pump system made of durable materials for use in an electronically controllable hydraulic system comprised of: (a) an electrically driven stepper motor; (b) a hydraulic pump to pressurize a hydraulic fluid; (c) a means to connect the stepper motor to the hydraulic pump; (d) a pressurized reservoir for a quantity of hydraulic fluid; (e) a means to supply pressurized fluid to a hydraulic actuator; (f) the hydraulic actuator with a means to provide linear motion to an object; (g) the means to provide linear motion to an object; (h) a means to return lowered pressurized fluid to the reservoir. An alternative embodiment is further comprised of a controller with a series of feedback signals.

The “Dynaco Stepper Pump Hydraulics System” 11 operates to use a stepper motor 21 to drive a pump 13 which provides high pressure hydraulic fluid to a ram 15 and piston 16. Additionally consider the following points as to this operation:

(1) The generated pressures (forces) are less than traditional systems: 1200 psi (prototype) versus 4000 psi—however, it depends on the size of the motor, the pump, and the speed the ram has to move. The combination of incredible strength with detailed accuracy enables our unique configuration to benefit multiple industries. For example, compared to conventional robotic manipulators, our system provides a superior ratio between lift capacity versus precision control, allowing our technology to significantly benefit industrial robotics applications, including the aircraft industry. Specifically, if a ram needs to lift 2 to 3 tons with absolute control, the Dynaco system can do it . . . and can do so without the need of a power pack.

(2) When a component is moved by a hydraulic ram (actuator):

(a) determine the present position of the component,

(b) provide an input to an stepper motor that is directly attached to the electrically driven positive displacement hydraulic pump to drive the pump through sufficient turns, allowing the actuator to move the component from the present location to a desired location, and

(c) the ram receives a command to move the component to the desired location.

(3) Basis of the “Dynaco Stepper Pump Hydraulics System”

(a) when controlling the operation of the stepper motor to drive the electrically driven positive displacement pump, we can control the hydraulic ram;

(b) by accurately holding the electrically driven positive displacement pump still (or controlling it to displace a controlled amount of fluid), the system can function without a control valve;

(c) it is not necessary to continuously run the electrically driven positive displacement pump to maintain required hydraulic pressure because the pump can be slowly turned to hold the ram at a desired extension to compensate for any system leakage that occurs;

(d) it allows for a new way to control a mechanical component that is moved by a hydraulic actuator (see #2 above);

(e) by feeding “position information” from a displacement transducer to a microprocessor based controller, the rotation of the output shaft of the stepper motor can be more accurately controlled, allowing for more accurate control of the movement of the ram. This functionality results in overall increased accuracy of the hydraulic system;

(f) electronically controlled inputs to the stepper motor allows for its output shaft to be held fixed or moved through a number of desired revolutions;

(g) by combining the output shaft of the stepper motor to the electrically driven positive displacement pump (so they are one unit), the smallest controlled movements of the motor results in the ability to control the hydraulic ram with a high degree of precision. In fact, for every drop of fluid that is displaced by the pump, a drop of fluid will be fed into the ram, moving the spear ever so subtly; and

(h) the reservoir 25 and fluid 26 is pressurized with compressed gas 27 (air or inert gas) to allow a positive flow of fluid 26 to the positive displacement pump and to provide pressure to retract the hydraulic actuator or ram 15 because the pressure on each side of the piston within the reservoir is different.

FIGS. 5A through 5C are sketches of the “Dynaco Stepper Pump Hydraulics System” in several operating configurations. Shown here are the several configurations as the hydraulic drive and single actuator 40, hydraulic drive and multiple (parallel) actuators 45 and hydraulic drive and multiple (parallel and series) actuators 46. Please note well the control valve and regulator mechanism 36 with the shutoff valves 38 in the systems with multiple actuator/rams 15.

Additional Key Differences between the “Dynaco Stepper Pump Hydraulics System” and servo pump systems are:

(a) The “Dynaco Stepper Pump Hydraulics System” is well suited for applications that start from zero speed needing maximum torque. A servo motor system will be at a disadvantage in these applications because it can only intermittently work in its maximum torque range at low speeds. Example: when controlling an aircraft flap, most corrections start from zero speed and need to immediately be at full torque. Size for size, a stepper motor can develop more starting torque than a servo motor at low speeds.

(b) The “Dynaco Stepper Pump Hydraulics System” can work ‘open loop’, without feedback. A servo motor driven system cannot because it has at least one feedback (motor speed). The benefit with this is that in some applications manual control would be desired, for example, driving a manipulator or robotic arm. In this scenario, the operator provides the feedback so an internal feedback system is not needed.

(c) Comparison Table. Generalized comparison of the “Dynaco Stepper Pump Hydraulics System” and servo driven hydraulic pump systems, comparing motors and pumps of similar size.

| | Dynaco Stepper | Servo Pump |
|---|---|---|
| Feature | Pump System | Systems |
| Speed (motor RPM) | Lower | Higher |
| Gearing Ratio | Higher | Lower |
| Wear | Lower | Higher |
| Torque | Higher | Lower |
| Efficiency | Higher | Lower |
| Control | Open & Closed | Closed Loop |
| | Loop | Only |
| Reliability | Higher | Lower |
| Mechanical | Lower | Higher |
| Components | | |
| Size and Weight | Lower | Higher |
| Scalability | Small to Large | Medium |

Explanation of Table

Speed
A stepper motor used in the “Dynaco Stepper Pump Hydraulics System” develops maximum torque at the lowest speed, while a servo motor in general has to rotate at about 1000 rpm to reach maximum torque.

Gearing Ratio
Because of the maximum torque at low speed, a stepper motor used in the “Dynaco Stepper Pump Hydraulics System” can drive a pump that displaces more fluid per revolution. A servo motor would have to drive a smaller pump or use mechanical gears, which increases complexity, wear and losses. A stepper motor used in the “Dynaco Stepper Pump Hydraulics System” can achieve very small increments and still displace very small amounts of oil, even with a larger pump.

Wear
With low speed and high gearing, the mechanical components used in the “Dynaco Stepper Pump Hydraulics System” are subjected to very little wear.

Efficiency
At low speeds, very little friction has to be overcome in the “Dynaco Stepper Pump Hydraulics System” and most of the electrical energy is converted to mechanical energy. A servo motor driven system will dissipate more heat.

Control
A servo driven system is “closed loop speed control” by its very nature, normally this is achieved by mounting an encoder on the shaft to provide motor speed (rpm) feedback to a control system. The “Dynaco Stepper Pump Hydraulics System” can be “open loop” without electronic feedback or “closed loop” with the following options:
   1) Position of the hydraulic actuator
   2) Hydraulic Pressure
   3) Motor Speed (rpm)
   4) Motor Current

Size and Weight
Because a servo driven system has to work harder than a Dynaco Stepper Pump Hydraulics System, the servo driven system has to be over-sized (when compared with the Dynaco Stepper Pump Hydraulics System) to compensate for the inefficiencies, especially if a mechanical gearbox is used to allow it to step down to get the desired torque.

Scalability
The “off the shelf” size ranges for stepper motors as used in the “Dynaco Stepper Pump Hydraulics System” are much greater (tiny to very large) than the size ranges for servo motors.

Many uses are anticipated for the “Dynaco Stepper Pump Hydraulics System 11. Some non-limiting examples are:

| ITEM | DESCRIPTION |
|---|---|
| 1 | Robotics - Robotic manipulator arms generally have a |
| | number of actuators (rams) with each controlling |
| | movements about a particular axis. Our invention allows |
| | for each actuator (ram) to be controlled by its own |
| | stepper motor driven hydraulic pump. Further, our micro- |
| | processor based control system controls the operation of |
| | each pump as well as the ram. This results in a robotic |
| | arm that is accurate with efficient action control and |
| | very compact, while also being incredibly powerful. |
| | Further, as opposed to one large and cumbersome power |
| | pack with proportional control valves, the Dynaco Stepper |
| | Pump Hydraulic System allows for individual power packs |
| | for each ram, located below the robotic arm, and for the |
| | respective hydraulic supplies to be provided via flexible |
| | hydraulic lines. |
| 2 | ROV Manipulator Arm - This can be a system that has |
| | open loop control (no electronic feedback), as the person |
| | who operates the arm provides the feedback by looking at |
| | the arm and moving it accordingly. |
| 3 | Remotely Operated Excavator - Similar to the ROV |
| | manipulator arm. |
| 4 | Industrial Robot Arm - Similar to the manipulator arm, |
| | but with feedbacks to ensure that each joint moves to the |
| | correct position. |
| 5 | Aircraft Control Surfaces - This application needs |
| | high torque, reliability and small size. The motor and |
| | pump can be located away from the actuators for weight |
| | distribution. Each flap can have its own hydraulic |
| | circuit and possibly even have redundant circuits. |
| 6 | Bio-medical - A stepper motor driven pump can be scaled |
| | down to operate very small hydraulic actuators. Example: |
| | an artificial hand could be operated by a small battery |
| | operated hydraulic power pack that is worn on a belt. |

It is important to observe that when a servo pump and the “Dynaco Stepper Pump Hydraulics System” are both configured and outfitted with equal feedback systems, the servo pump system has no advantage over a the “Dynaco Stepper Pump Hydraulics System”.

Traditionally, engineers have tended to provide additional feedback controls and specify a servo system as compared to the simple, segmented steps provided with the stepper motor. There are significant differences and advantages when using a stepper drive motor with the pump in a hydraulic system. Those skilled in the art of motor driven pumps have overlooked these improvements and advantages. Some have even taught away and discouraged the use of a stepper motor combined with a hydraulic pump in this manner. The combination of a stepper motor and pump for hydraulic systems is a very key advantage to the improved capabilities of the “Dynaco Stepper Pump Hydraulics System”. Technically speaking, the only advantage the servo pump would have is that it may better maintain constant pressure at a set amount of revs, say 1,000 rpm's. However, there is no reason one would want to do this since they could alternatively accomplish this with a conventional power pack hydraulics system.

With this description it is to be understood that the “Dynaco Stepper Pump Hydraulics System” 11 is not to be limited to only the disclosed embodiment of product. The features of the “Dynaco Stepper Pump Hydraulics System” 11 are intended to cover various modifications and equivalent arrangements included within the spirit and scope of the description.

While certain novel features of this invention have been shown and described and are pointed out in the annexed claims, it is not intended to be limited to the details above, since it will be understood that various omissions, modifications, substitutions and changes in the forms and details of the device illustrated and in its operation can be made by those skilled in the art without departing in any way from the spirit of the present invention. Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

Unless defined otherwise, all technical and scientific terms used herein have the same meaning as commonly understood by one of ordinary skill in the art to which these inventions belong. Although any methods and materials similar or equivalent to those described herein can also be used in the practice or testing of the present inventions, the preferred methods and materials are now described above in the foregoing paragraphs.

Other embodiments of the invention are possible. Although the description above contains much specificity, these should not be construed as limiting the scope of the invention, but as merely providing illustrations of some of the presently preferred embodiments of this invention. It is also contemplated that various combinations or sub-combinations of the specific features and aspects of the embodiments may be made and still fall within the scope of the inventions. It should be understood that various features and aspects of the disclosed embodiments can be combined with or substituted for one another in order to form varying modes of the disclosed inventions. Thus, it is intended that the scope of at least some of the present inventions herein disclosed should not be limited by the particular disclosed embodiments described above.

The terms recited in the claims should be given their ordinary and customary meaning as determined by reference to relevant entries (e.g., definition of “plane” as a carpenter's tool would not be relevant to the use of the term “plane” when used to refer to an airplane, etc.) in dictionaries (e.g., widely used general reference dictionaries and/or relevant technical dictionaries), commonly understood meanings by those in the art, etc., with the understanding that the broadest meaning imparted by any one or combination of these sources should be given to the claim terms (e.g., two or more relevant dictionary entries should be combined to provide the broadest meaning of the combination of entries, etc.) subject only to the following exceptions: (a) if a term is used herein in a manner more expansive than its ordinary and customary meaning, the term should be given its ordinary and customary meaning plus the additional expansive meaning, or (b) if a term has been explicitly defined to have a different meaning by reciting the term followed by the phrase “as used herein shall mean” or similar language (e.g., “herein this term means,” “as defined herein,” “for the purposes of this disclosure [the term] shall mean,” etc.). References to specific examples, use of “i.e.,” use of the word “invention,” etc., are not meant to invoke exception (b) or otherwise restrict the scope of the recited claim terms. Other than situations where exception (b) applies, nothing contained herein should be considered a disclaimer or disavowal of claim scope. Accordingly, the subject matter recited in the claims is not coextensive with and should not be interpreted to be coextensive with any particular embodiment, feature, or combination of features shown herein. This is true even if only a single embodiment of the particular feature or combination of features is illustrated and described herein. Thus, the appended claims should be read to be given their broadest interpretation in view of the prior art and the ordinary meaning of the claim terms.

Unless otherwise indicated, all numbers or expressions, such as those expressing dimensions, physical characteristics, etc. used in the specification (other than the claims) are understood as modified in all instances by the term “approximately.” At the very least, and not as an attempt to limit the application of the doctrine of equivalents to the claims, each numerical parameter recited in the specification or claims which is modified by the term “approximately” should at least be construed in light of the number of recited significant digits and by applying ordinary rounding techniques.

What is claimed is:

1. An electrically driven hydraulic pump for use in an electronically controllable hydraulic system, the electrically driven hydraulic pump having an electrically driven stepper motor and a positive displacement hydraulic pump connected to an output shaft of the electric motor
wherein the electric motor is configured such that the electric motor's output shaft can be held fixed, or be moved through a desired number of revolutions or parts thereof, in response to electronically controlled electrical inputs to the electric motor.

2. An electrically driven proportional hydraulic pump system made of durable materials for use in an electronically controllable hydraulic system comprised of:
(a) an electrically driven stepper motor;
(b) a hydraulic positive displacement pump to pressurize a hydraulic fluid;
(c) a means to connect the stepper motor to the hydraulic pump;
(d) a reservoir for a quantity of hydraulic fluid;
(e) a means to supply pressurized fluid to an hydraulic actuator;
(f) a means to return lowered pressurized fluid to the reservoir.

3. The device according to claim 2 further comprised wherein the reservoir has a fluid that is pressurized with a compressed gas which allows a positive flow of the fluid to a positive displacement pump.

4. The device according to claim 2 wherein the hydraulic pump is a sprocket gear pump.

5. The device according to claim 2 wherein the hydraulic pump is a worm gear pump.

6. The device according to claim 2 wherein the hydraulic pump is a centrifugal pump.

7. The device according to claim 2 wherein the hydraulic pump is a piston pump.

8. The device according to claim 2 wherein the hydraulic pump drives a plurality of actuators.

9. The device according to claim 2 wherein the hydraulic pump is further comprised of a controller with a series of feedback signals.

10. The device according to claim 8 wherein the feedback signals is from the group consisting of electrical current—amp, motor/shaft speed—RPM, hydraulic fluid pressure—psi, and actuator position—position to datum.

11. The device according to claim 2 further comprised of:
(g) a hydraulic actuator with a means to provide motion to an object;
(h) the means to provide motion to an object;

12. The device according to claim 11 where the means to provide motion is linear.

13. The device according to claim 11 wherein the hydraulic pump is further comprised of a controller with a series of feedback signals.

14. The device according to claim 13 wherein the feedback signals is from the group consisting of electrical current—amp, motor/shaft speed—RPM, hydraulic fluid pressure—psi, and actuator position—position to datum.

15. The device according to claim 2 wherein the durable material is from the group consisting of metal; steel; steel alloy; aluminum; brass; pot metal; a heavy duty, durable plastic; and a composite material.
